(19) United States
(12) Patent Application Publication
(10) Pub. No.: US 2026/0044433 A1
(43) Pub. Date: Feb. 12, 2026

(54) SYSTEM AND METHOD FOR PERFORMANCE TESTING SOFTWARE PRODUCTS

(71) Applicant: ServiceNow, Inc., Santa Clara, CA (US)

(72) Inventors: Sudhakar Reddy Narra, Round Rock, TX (US); Srikanth Reddy Vanteddu, Round Rock, TX (US); Eugene Vikutan, Sunnyvale, CA (US); Dhananjay Sen, Bangalore (IN); Andriy Blazhiyevskiy, Danville, CA (US)

(21) Appl. No.: 18/799,255

(22) Filed: Aug. 9, 2024

(51) Int. Cl. G06F 11/36

(52) U.S. Cl. CPC G06F 11/3616; G06F 11/3612; G06F 11/3698

(57) ABSTRACT

A method including receiving a request to generate a performance test associated with an application, wherein the request specifies a performance characteristic associated with the application, and generating, based on the performance characteristic, the performance test. The method also includes directing execution of the performance test to the application, generating, based on execution of the performance test, a performance metric indicative of the performance characteristic, and compiling the performance metric with one or more additional performance metrics associated with the application.

### TECHNICAL FIELD

The present disclosure relates generally to a software product performance testing tool. Specifically, the present disclosure relates to performance testing of various software products across a platform of an enterprise.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Organizations, regardless of size, rely upon access to information technology (IT) and data and services for their continued operation and success. A respective organization's IT infrastructure may have associated hardware resources (e.g. computing devices, load balancers, firewalls, switches, etc.) and software resources (e.g. productivity software, database applications, custom applications, and so forth). Over time, more and more organizations have turned to cloud computing approaches to supplement or enhance their IT infrastructure solutions.

Cloud computing relates to the sharing of computing resources that are generally accessed via the Internet. In particular, a cloud computing infrastructure allows users, such as individuals and/or enterprises, to access a shared pool of computing resources, such as servers, storage devices, networks, applications, and/or other computing-based services. By doing so, users are able to access computing resources on demand that are located at remote locations and such resources may be used to perform a variety computing functions (e.g., storing and/or processing large quantities of computing data).

Performance testing is used to test and monitor software products (e.g., portions of code, artifacts, applications) within cloud computing environments. Performance testing applications may provide generalized testing protocols and analytics based on manually propagated test scripts. Conventional performance testing applications in many instances execute siloed testing with limited real-time monitoring due to latency between execution of performance testing and reporting of performance testing results. Executing performance testing without consistency and integration across environments and applications is an inefficient use of computing resources. With ever increasing implementation of new software products, accurate and reliable performance testing that is computationally efficient is challenging. As such, real-time analytics during automated performance testing may improve performance testing and monitoring of software products of an enterprise.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

A performance testing tool is disclosed herein that enables streamlined performance testing for applications within a platform of an enterprise. The performance testing tool may offer consistent performance testing across various environments and applications. In this manner, the performance testing tool may provide real-time performance metrics to maintain reliability of environments and applications. Further, the performance testing tool may be integrated within a continuous integration (CI), continuous deployment (CD) platform of the enterprise.

In certain aspects, the present disclosure is generally directed to a method including receiving a request to generate a performance test associated with an application, wherein the request specifies a performance characteristic associated with the application, and generating, based on the performance characteristic, the performance test. The method also includes directing execution of the performance test to the application, generating, based on execution of the performance test, a performance metric indicative of the performance characteristic, and compiling the performance metric with one or more additional performance metrics associated with the application.

The present disclosure is directed to a system including processing circuitry and memory, accessible by the processing circuitry, the memory storing instructions that, when executed by the processing circuitry, cause the processing circuitry to perform operations. The operations include receiving a request to generate a performance test associated with an application, wherein the request specifies a performance characteristic associated with the application and generating, based on the performance characteristic, the performance test. The operations also include directing execution of the performance test to the application, generating, based on execution of the performance test, a performance metric indicative of the performance characteristic, and compiling the performance metric with one or more additional performance metrics associated with the application.

The present disclosure is directed to a non-transitory computer-readable storage medium including processor-executable routines that, when executed by a processor, cause the processor to perform operations. The operations include receiving a request to generate a performance test associated with an application, wherein the request specifies a performance characteristic associated with the application and generating, based on the performance characteristic, the performance test. The operations also include directing execution of the performance test to the application, generating, based on execution of the performance test, a performance metric indicative of the performance characteristic, and compiling the performance metric with one or more additional performance metrics associated with the application. Further, the operations include generating a notification based on the compiled performance metrics and providing the notification to a client device via a user interface.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a multi-instance cloud architecture in which embodiments of the present techniques may operate;

FIG. 2 is a schematic diagram of an embodiment of a multi-instance cloud architecture in which embodiments of the present techniques may operate;

FIG. 3 is a block diagram of a computing device utilized in a computing system that may be present in FIG. 1 or 2, in accordance with aspects of the present techniques;

FIG. 4 is a block diagram illustrating an embodiment in which a virtual server supports and enables the client instance, in accordance with aspects of the present techniques;

FIG. 5 is a schematic illustrating a framework of a performance testing tool to be utilized within an enterprise, in accordance with aspects of the present techniques;

FIG. 6 is a schematic embodiment of an architecture of the performance testing tool of FIG. 5, in accordance with aspects of the present techniques;

FIG. 7 is a schematic embodiment of a graphical user interface (GUI) generated within the performance testing tool of FIGS. 5 and 6, in accordance with aspects of the present techniques;

FIG. 8 is a schematic embodiment of a screen displaying a live performance testing session of the performance testing tool of FIGS. 5 and 6, in accordance with aspects of the present techniques;

FIG. 9 is a flow chart of a process of performing a performance test and generating one or more performance metrics, in accordance with aspects of the present techniques;

FIG. 10 is a flow chart of a process of generating a notification based on a performance metric and/or one or more performance issues, in accordance with aspects of the present techniques; and

FIG. 11 is a flow chart of a process for performing a live performance testing session, in accordance with aspects of the present techniques.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers'specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function(s) described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

In addition, as used herein, the terms “real time”, “real-time”, or “substantially real time” may be used interchangeably and are intended to describe operations (e.g., computing operations) that are performed without any human-perceivable interruption between operations. For example, as used herein, data relating to the systems described herein may be collected, transmitted, and/or used in control computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “automatic”, “automated”, “autonomous”, and so forth, are intended to describe operations that are performed are caused to be performed, for example, by a computing system (i.e., solely by the computing system, without human intervention). Indeed, although certain operations described herein may not be explicitly described as being performed automatically in substantially real time during operation of the computing system and/or equipment controlled by the computing system, it will be appreciated that these operations may, in fact, be performed automatically in substantially real time during operation of the computing system and/or equipment controlled by the computing system to improve the functionality of the computing system (e.g., by not requiring human intervention, thereby facilitating faster operational decision-making, as well as improving the accuracy of the operational decision-making by, for example, eliminating the potential for human error), as described in greater detail herein.

In modern communication networks, examples of cloud computing services include software as a service (SaaS) and platform as a service (PaaS) technologies. SaaS is a delivery model that provides software as a service rather than an end product. Instead of utilizing a local network or individual software installations, software is typically licensed on a subscription basis, hosted on a remote machine, and accessed by client devices as needed. For example, client devices are generally able to access a variety of enterprise and/or information technology (IT)-related software via a web browser. PaaS acts as an extension of SaaS that goes beyond providing software services by offering customizability and expandability features to meet a user's needs. For example, PaaS can provide a cloud-based developmental platform for developing, testing, modifying, and/or customizing applications and/or automating enterprise operations without maintaining network infrastructure and/or allocating computing resources normally associated with these functions.

These cloud computing services may provide applications and/or websites for user engagement. With ever increasing implementation of new software products provided in cloud computing environments, accurate and reliable performance testing that is computationally efficient is needed. Performance testing of the applications may ensure that these cloud computing services may be capable of handling traffic, preventing bottlenecks and vulnerabilities, handling heavy loads, and addressing additional issues. For example, executing performance testing of applications may provide insight to a speed, a responsiveness, a stability, a load time, a scalability, of the applications. As such, the enterprise may seek to integrate performance testing to test and monitor software products (e.g., portion of code, artifacts, applications) within cloud computing environments. Currently, there is no streamlined process for incorporating performance testing into cloud computing environments to identify performance issues and compile performance metrics across cloud computing environments of the enterprise.

Conventional performance testing applications typically operate by executing performance testing of a specific portion of an application and/or a single application within the cloud computing environment. As such, there may be a lack of communication of performance issues across the cloud computing environment. Further, such conventional performance testing application are limited with respect to real-time monitoring and active performance (e.g., debugging) analysis due to latency between execution of performance testing and reporting of performance testing metrics. The lack of real-time monitoring during performance testing limits the level of granularity and/or collation of performance testing metrics, which may lead to performance problems (e.g., bottlenecks) in software products. As such, there is a need for consistent and near real-time integration of performance testing across cloud computing environments and applications.

Accordingly, the presently disclosed techniques may be used to improve techniques for generating real-time performance metrics during automated performance testing to improve performance testing and monitoring of software products of an enterprise. A performance testing tool is disclosed herein to streamline performance testing for applications. The performance testing tool provides testing of various software products across a platform of an enterprise. In this manner, the performance testing tool may automatically identify performance metrics related to the various software products, generate performance reports in real-time or near-real-time, and provide performance analytics based on performance reports. For example, the performance testing tool is configured to automatically execute consistent performance tests across environments and applications. As such, the performance testing tool may be integrated within a continuous integration (CI), continuous deployment (CD) platform. In this manner, the performance testing tool may be integrated with existing architectures of the enterprise to provide streamlined creation and management of performance testing from a centralized source. Further, the performance testing tool may provide real-time performance metrics to provide correction and/or update to software products to maintain reliability of environments and applications across the enterprise. Further, the performance testing tool may provide analytics based on multiple performance tests executed across different application and environments of the enterprise. In this manner, performance metrics may be compiled to provide relevant and consistent performance analytics over time. Additionally, present embodiments include a graphical user interface (GUI) designed to present performance metrics and/or performance analytics of the performance testing tool in a concise and organized format, which enables streamlining of performance testing into existing platforms of the enterprise.

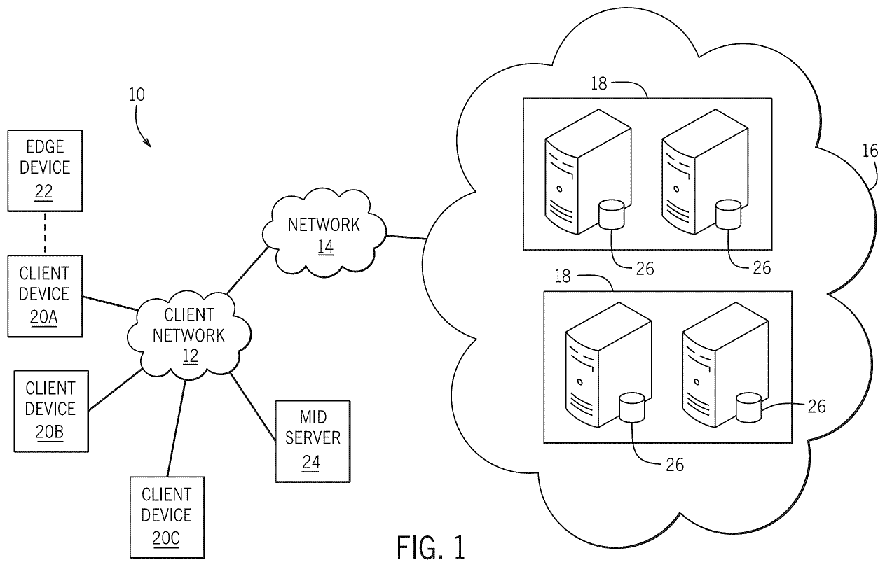

With the preceding in mind, the following figures relate to various types of generalized system architectures or configurations that may be employed to provide services to an organization in a multi-instance framework and on which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In some implementations, the cloud-based platform 16 may be a configuration management database (CMDB) platform in which hardware, software, and/or other aspects of the client network 12 and/or cloud-based platform are regularly tracked and monitored. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, and 20B so that the client devices are able to communicate with each other and/or with the network hosting the platform 16. The client devices 20 may be computing systems and/or other types of computing devices generally referred to as Internet of Things (IoT) devices that access cloud computing services, for example, via a web browser application or via an edge device 22 that may act as a gateway between the client devices 20 and the platform 16. FIG. 1 also illustrates that the client network 12 includes an administration or managerial device, server, or software-implemented agent, such as a management, instrumentation, and discovery (MID) server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to a network 14. The network 14 may include one or more computing networks, such as other LANs, wide area networks (WAN), the Internet, and/or other remote networks, to transfer data between the client devices 20 and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20 via the client network 12 and network 14. The network hosting the platform 16 provides additional computing resources to the client devices 20 and/or the client network 12. For example, by utilizing the network hosting the platform 16, users of the client devices 20 are able to build and execute applications for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to as application nodes, application servers, virtual server instances, application instances, or application server instances), where one or more virtual servers 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

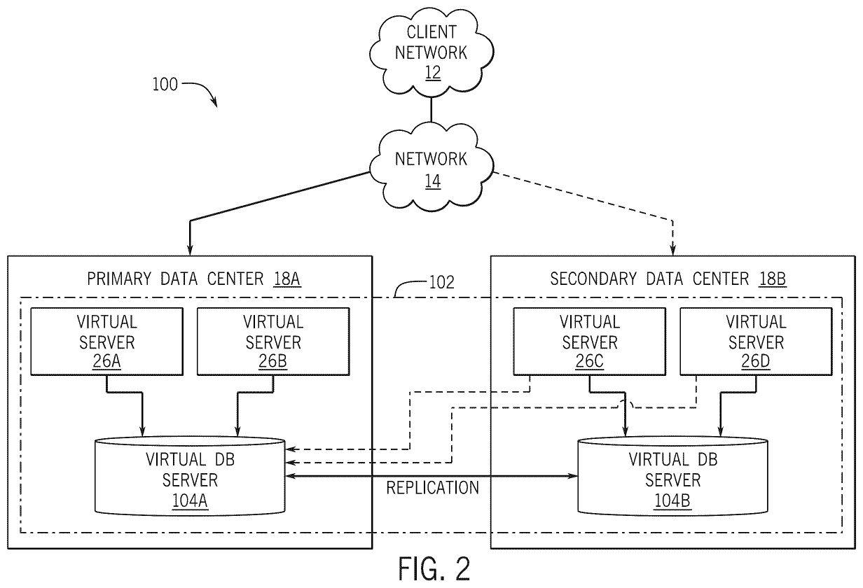

In another embodiment, one or more of the data centers 18 are configured using a multi-instance cloud architecture to provide every customer its own unique customer instance or instances. For example, a multi-instance cloud architecture could provide each customer instance with its own dedicated application server and dedicated database server. In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, the disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

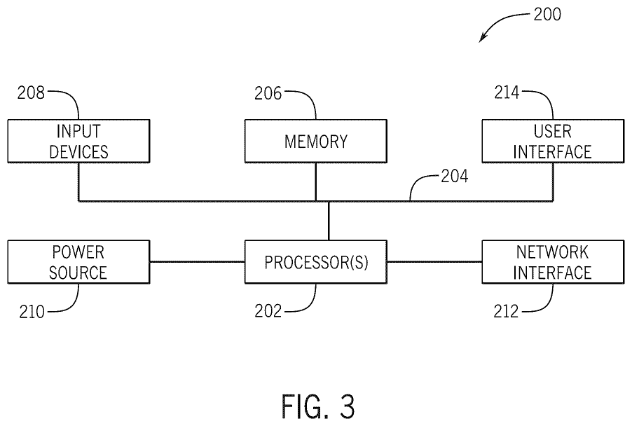

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computer system may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202, one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition to and/or alternative to the display, the user interface 214 may include other devices for interfacing with a user, such as lights (e.g., LEDs), speakers, and the like.

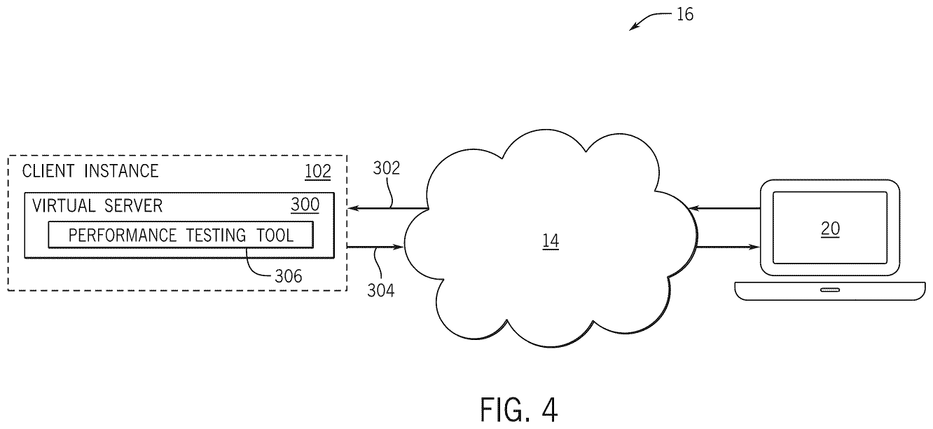

With the preceding in mind, FIG. 4 is a block diagram illustrating an embodiment in which a virtual server 300 supports and enables the client instance 102, according to one or more disclosed embodiments. More specifically, FIG. 4 illustrates an example of a portion of a service provider cloud infrastructure, including the cloud-based platform 16 discussed above. The cloud-based platform 16 is connected to a client device 20 via the network 14 to provide a user interface to network applications executing within the client instance 102 (e.g., via a web browser of the client device 20). Client instance 102 is supported by virtual servers 300 similar to the virtual servers 26 explained with respect to FIG. 2, and is illustrated here to show support for the disclosed functionality described herein within the client instance 102. Cloud provider infrastructures are generally configured to support a plurality of end-user devices, such as client device 20, concurrently, wherein each end-user device is in communication with the single client instance 102. Also, cloud provider infrastructures may be configured to support any number of client instances, such as client instance 102, concurrently, with each of the instances in communication with one or more end-user devices. As mentioned above, an end-user may also interface with client instance 102 using an application that is executed within a web browser.

As shown, the client device 20 may interact with the client instance 102 by providing inputs 302, to which the client instance 102 may respond with outputs 304. In the embodiment shown in FIG. 4, the virtual servers 300 of the client instance 120 may run a performance testing tool 306, which may be a software application defined by code, accessible via a native application or web browser of the client device 20. Accordingly, the inputs 302 may include inputs requesting performance testing, and so forth. In some embodiments, the performance testing tool 306 may be hosted by the client instance 102. The performance testing tool may be used to identify performance metrics related to various software products, generate performance reports, and provide performance reports. The client instance 102 hosting the performance testing tool may be accessible via the client device 20. In this manner, the performance testing tool may automatically identify performance issues associated with portions of code, artifacts, and/or applications of the enterprise within the cloud provide infrastructures of the enterprise.

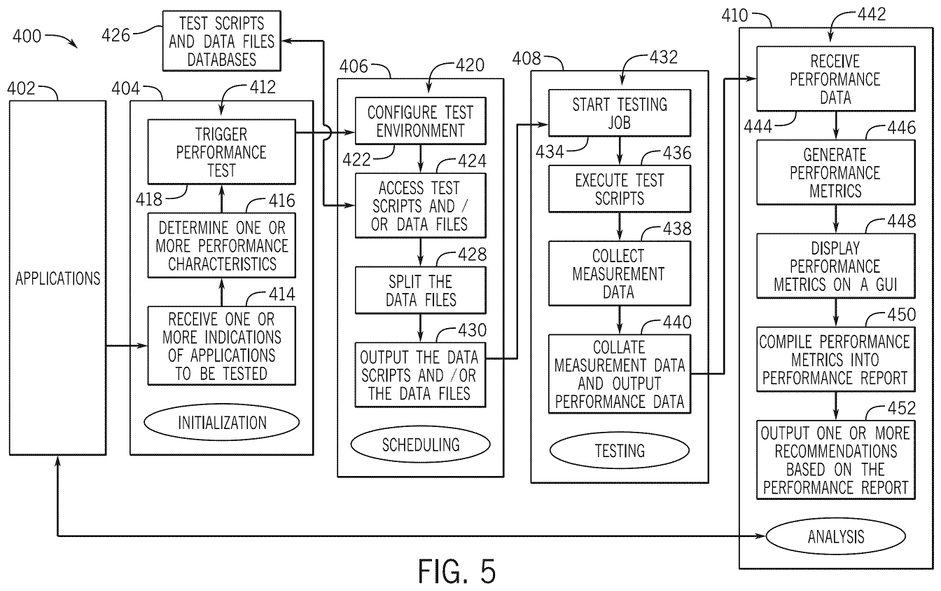

With this in mind, FIG. 5 is a framework 400 of a performance testing tool 306 to be utilized within an enterprise. The performance testing tool 306 may be used to run performance testing of one or more applications 402 used and/or developed by the enterprise. The performance testing tool 306 may be executed from the platform 16 of the enterprise. As such, the performance testing tool 306 may be embedded within the platform 16 of the enterprise. The applications 402 of the enterprise may include one or more enterprise generated applications, one or more application clones, one or more customized applications, and the like. For example, the applications 402 may be used to execute various enterprise, IT, and/or other organization-related functions. The framework 400 of the performance tool 306 may include various stages to identify, plan, implement, execute, and analyze performance of the applications 402. It should be noted, the framework 400 of FIG. 5 is one non-limiting example of the performance testing tool 306 and that the illustrated stages are provided as examples and more, fewer, or different stages may be included in the framework 400 of the performance testing tool 306. Further, one or more stages of the framework 400 may be executed by the client device 20, or any other suitable device(s) or controller(s).

As shown, the stages encompassed in the performance testing tool 306 may include an initialization stage 404, a scheduling stage 406, a testing stage 408, and an analysis stage 410. The initialization stage 404 includes an identification workflow 412 that may be followed to establish testing criteria of the applications 402 to be evaluated. The initialization stage 404 may receive an indication of one or more applications 402 to be tested by the performance testing tool 306 at block 414 of identification workflow 412. The indication may be received from the client network 12, the network 14 (e.g., the Internet), and/or the cloud-based platform 16 of the enterprise. In some embodiments, the indication of the applications 402 to be tested by the performance testing tool 306 may be automatically received as an input of a CI/CD platform of the enterprise. For example, the performance testing tool 306 may be integrated within the CI/CD platform. In this manner, updates and/or changes to the CI/CD platform may automatically provide inputs to execute the initialization stage 404 of the framework 400.

The identification workflow 412 may determine one or more performance characteristics at block 416. In some embodiments, the performance characteristics may include a response time, a scalability, a reliability, a speed, a responsiveness, a throughput, semaphore utilization, hardware utilization, network utilization, software utilization, one or more slow patterns, one or more bottlenecks, and the like. As such, the performance characteristics may be selected to test usage features of applications 204 indicated for testing. In this manner, the performance characteristics may be used to determine testing protocols to identify performance metrics of one or more selected performance characteristics. As such, the identification workflow 412 may establish the performance characteristics associated with the applications based on anticipated workloads, concurrency, and additional operating conditions of the applications 204 received for performance testing. In certain embodiments, the enterprise may establish specific performance characteristics that may be used to inform performance test generation of multiple applications. As such, testing results and/or performance metrics of various application may be directly compared. In this manner, defining the performance characteristics on an enterprise may provide consistent, configurable, and comparable performance reports for use in evaluation processes across the platform 16 of the enterprise.

The identification workflow 412 may trigger a performance test at block 418. In some embodiments, the performance testing tool 306 may identify a testing environment of the application 402 upon trigger of the performance test. The testing environment may include hardware configurations, software configurations, and/or network configurations associated with the applications 402 indicated for testing. The testing environment may be identified as a designated testing environment of the enterprise, a production environment, a development environment, or a combination thereof. In this manner, the performance testing tool 306 may be initiated based on the identified testing environment. In some embodiments, multiple environments may be identified for testing the applications 402. As such, initialization of the performance test may provide the performance characteristics and/or the testing environment related to the applications 204 to be tested to the scheduling stage 406 of the framework 400.

The scheduling stage 406 of the framework 400 includes a development workflow 420. The development workflow 420 may provide one or more processes to prepare the performance test for execution. In some embodiments, the development workflow 420 may configure the test environment at block 422. Configuration of the test environment may include preparing one or more elements of the performance test. The elements may be used to monitor testing of the performance characteristics during testing. For example, the test environment may need to be isolated for testing to prevent impact of activity of the application not related to testing. In this manner, one of the elements may include a testing time. The testing time may be used to schedule performance testing based on an availability of the test environment.

The development workflow 420 may access one or more test scripts and/or one or more data files at block 424. The test scripts may include a portion of code that when executed may be used to emulate one or more anticipated workloads of the applications 402. As such, the test scripts may probe a behavior of the performance characteristics of the applications 402. In this manner, the test scripts may include specific portions of code to probe responses to a specific load (e.g., concurrent instances), a capacity, an ability to handle a sustained load, a spike in load, one or more predetermined failure conditions, and the like. In certain embodiments, the data files may include customizable inputs that may be used by the test script to simulate one or more inputs of various users during execution of the test script. For example, the data files may include a list of parameters that may be used by the test scripts to simulate a plurality of users accessing a particular application at one or more times throughout a day. As such, the performance test may be able to use the data files to represent user behavior during execution of the performance test. In some embodiments, the test scripts may be uploaded directly to the performance testing tool 306. As such, testing scripts may be executed without platform-specific coding.

In some embodiments, the development workflow 420 may access the test scripts and/or the data files from a database of the enterprise 426. Additionally and/or alternatively, the performance testing tool 306 may access one or more automation scripts from the databased on the enterprise 426. The automation scripts may be automatically propagated to the test environments and the applications 402 being tested by the performance testing tool 306. As such, the automation scripts may be executed across multiple applications, test environments, and data centers of the enterprise without manual propagation. As such, the performance testing tool 306 may be integrated to automatically test performance of applications 402 at various points during development, deployment, and/or operation of the applications 402. In this manner, metrics may be generated over time to analyze a performance of the applications 402.

The development workflow 420 may split the data file at block 428. In some embodiments, the performance testing tool 306 may use one or more processors and/or testing environments to execute testing of the applications. In this manner, the data file may be divided to avoid executing performance testing using a particular data set concurrently (e.g., the performance testing tool 306 may use different portions of the data file for subsequent and/or concurrent performance testing). As such, the performance testing tool 306 may generate various subsets of data from the data file to use during performance testing. In this manner, iterations of performance testing may use distinct subsets of data during testing.

The development workflow 420 may output the data scripts and/or the data files at block 430. The data scripts and/or the data files may be provided to the testing stage 408 of the framework 400. The testing stage 408 of the framework 400 includes an execution workflow 432 that may be used to conduct performance testing of the applications 402. The execution workflow 432 may start a testing job at block 434. The testing job may be executed in a particular testing environment and may test for the one or more performance characteristics determined by the initialization stage 404. In some embodiments, one or more testing jobs may be considered as a performance test of the application 402. As such, a particular testing job may test performance of a particular performance characteristic. For example, a first testing job may measure a response time of the applications. The response time may include an amount of total time to send a request and receive a response to the request. Further, a second testing job may measure an average load time. The average load time may include an average amount of time the applications take to generate responses to each received request. In this way, the testing jobs may simultaneously and/or subsequently test each performance characteristics to determine a performance strength of the applications 402.

In some embodiments, the execution workflow 432 may execute one or more test scripts at block 436. The test scripts may include a load test, a stress test, a spike test, an endurance test, a scalability test, a volume test, and the like. The test scripts may be executed to test the performance characteristics of the applications 402 by simulating various scenarios. For example, the test scripts may execute a load test by simulating various users accessing a particular portion of the application 402 at a particular time. It should be noted, that in some embodiments, the test scripts may be executed simultaneously with block 434 of the execution workflow 432.

The execution workflow 432 may collect measurement data at block 438. In certain embodiments, during execution of the performance measurement data may be collected based on performance of the applications 402 in different testing environments and simulated workloads generated by the test scripts. The measurement data may include a response time, a wait time, a load time, an amount of errors, a number of concurrent users, a requests per second, a number of successful transactions, a number of unsuccessful transactions, a throughput, a hardware utilization (e.g., time hardware may need to process requests), a memory utilization (e.g., an amount of memory used during the performance test), and the like. Each of the testing jobs may generate measurement data related to a particular performance characteristic of the applications 402. As such, the performance test may generate multiple sets of measurement data. For example, the first testing job may output a first set of measurement data directed to the amount of total time to send a request and receive a response to the request. Further, the second testing job may generate a second measurement data set including data related to the average load time of the application 402.

In some embodiments, the execution workflow 432 may collate measurement data and output performance data at block 440. The performance data set may include one or more sets of measurement data from one or more testing jobs of the performance testing tool 306. As such, the performance data may include data related to each of the performance characteristics tested during execution of the performance test by the performance testing tool 306. In some embodiments, the performance data may be stored in one or more databases. Further, in certain embodiments, the performance data may be provided to the analysis stage 410 of the framework 400 for analysis.

The analysis stage 410 of the framework 400 includes a performance metrics workflow 442. The performance metrics workflow 442 may assess a performance of the applications 402 and/or may provide a performance report that may be used to inform changes to the applications 402 based on performance analytics of the performance test. In some embodiments, the performance metrics workflow 442 may receive performance data at block 444. The performance data may be generated by one or more performance tests executed on one or more applications 402. In certain embodiments, the performance testing tool 306 may access one or more databases to access the performance data generated during the testing stage 408. The performance testing tool 306 may organize the performance data prior to analysis. Organization of the performance data may be based on a type of measurement data included in a performance data set. For example, the analysis stage 410 may first performance analysis on a particular performance characteristic response across many applications 402. As such, the performance testing tool 306 may sort the performance data to identify data related to the particular performance characteristic.

In some embodiments, the performance metrics workflow 442 may generate one or more performance metrics at block 446. The performance metrics may be indicative of the performance characteristic tested by the performance testing tool 306. In some embodiments, the performance metrics may include an error rate, a concurrency rate, a hardware utilization percentage (e.g., CPU percentage usage), a memory utilization percentage, a network utilization percentage, a comparison of one or more measurement data sets, and the like. In some embodiments, the performance metrics may be normalized to provide metrics that may be comparable to previous and/or future performance tests of the applications 402. Further, normalization of the performance metrics may enable the performance testing tool 306 to compare performance metrics of various applications and testing environments. For example, the performance testing tool 306 may compare the network utilization percentage of various applications running on a single network to determine a network stain. As such, the performance testing tool 306 may analyze an overall performance of the single network as a factor of the performance metrics of one or more individual applications 402. In certain embodiments, the performance testing tool 306 may generate performance metrics that may be used to inform operation of the CI/CD platform of the enterprise. In this manner, the CI/CD platform may be automatically updated based the performance metrics of various applications.

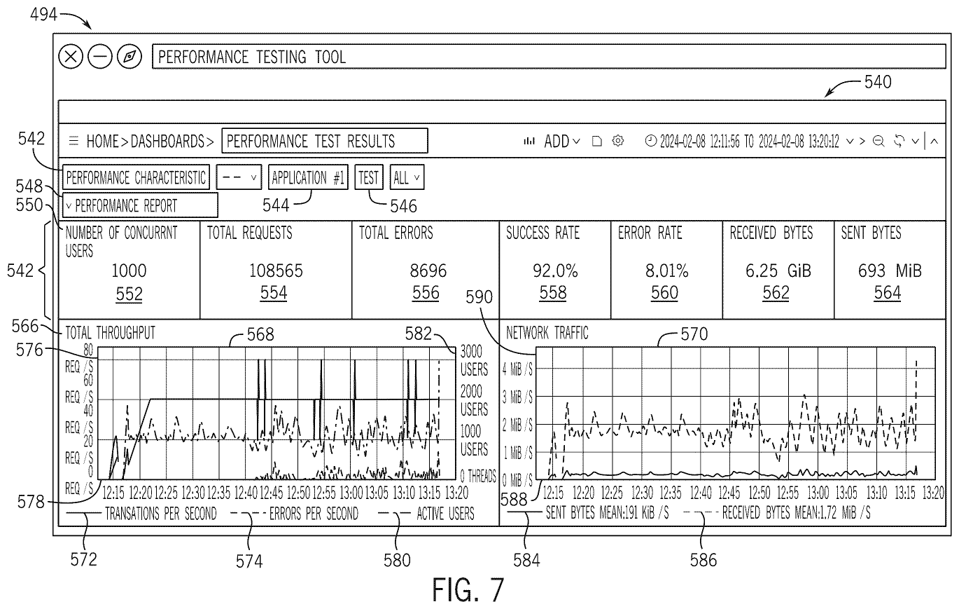

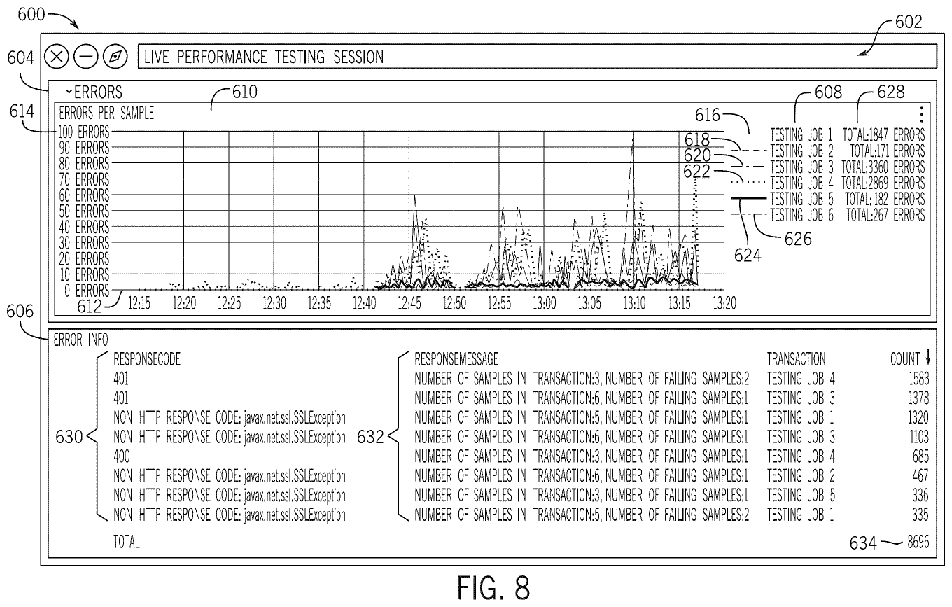

The performance metrics workflow 442 may display the performance metrics in a graphical user interface (GUI) at block 448. In some embodiments, one or more instances of customers, IT, and/or other suitable clients of the enterprise may access the GUI to access the performance metrics. The GUI may provide the performance metrics through one or more graphs as discussed further in regards to FIG. 7. Additionally and/or alternatively, the GUI may provide a live performance testing session, discussed below in reference to FIG. 8. The live performance testing session may be used to conduct near real-time monitoring and analysis of performance of the applications 402 of the enterprise. In this manner, the performance testing tool 306 may use the live performance testing session to identify bottlenecks, slow patterns, and the like in near real-time as the performance test is being executed.

The performance metrics workflow 442 may compile the performance metrics into a performance report at block 450. In some embodiments, the performance testing tool 306 may compile the performance metrics into the performance report to provide insight into an overall performance of the applications 402. The overall performance of the applications 402 may be provided by assigning a score to results of the performance test. In this manner, a second performance test may be compared with a second performance test. Comparison of the scores of the performance test may provide insight to improvement of the applications 402 to support customer usage over a given period of time (e.g., days, months, years). Further, the performance testing tool 306 may provide analytics within the performance report based on multiple performance tests executed across different application and environments of the enterprise. In this manner, the performance reports may be used to provide relevant and consistent performance analytics over time.

The performance metrics workflow 442 may output one or more recommendations based on the performance report at block 452. The one or more recommendations may be based on the performance analytics provided within the performance report, performance metrics, comparison of the performance metrics to one or more additional performance tests, or a combination thereof. The recommendations may include a directive to update a software component, a hardware component, a network component, optimize one or more portion of code, and the like. In certain embodiments, the recommendations may be based on a known enterprise directive to reduce a particular slow pattern, bottleneck, and the like during usage of the applications 402.

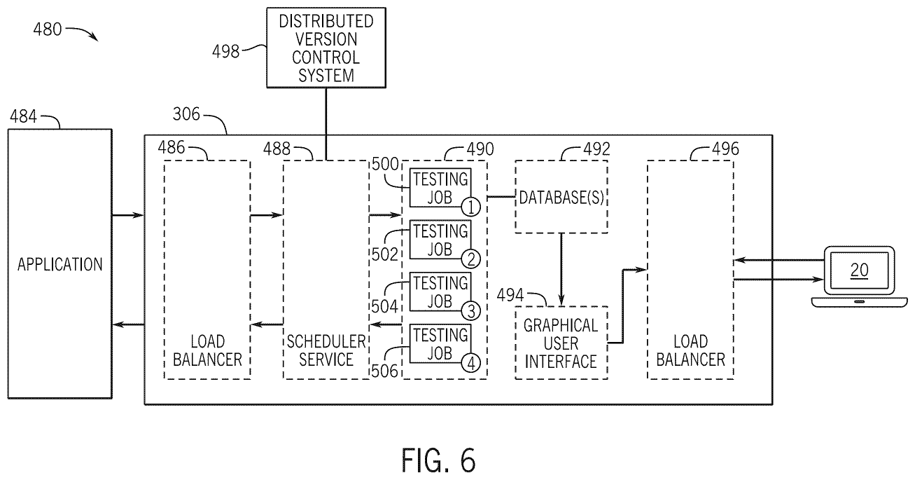

With the foregoing in mind, FIG. 6 is a schematic embodiment of an architecture 480 of a performance testing tool 306. The performance testing tool 306 may communicate with an application 484 of the enterprise, a client device 20, or a combination thereof. In some embodiments, the application 484 may be a module of the platform 16 of the enterprise. The performance testing tool 306 may be used to execute performance testing of the application 484 and provide performance metrics to the client device 20. The performance testing tool 306 may follow the workflows 412, 420, 432, 442 as outlined in the framework 400 of FIG. 5. In certain embodiments, the performance testing tool 306 may include a first load balancer 486, a scheduler service 488, one or more testing jobs 490, one or more databases 492, a graphical user interface 494, and a second load balancer 496. It should be noted, that the performance testing tool 306 may include one or more different, fewer, or additional components to perform performance testing of the application 484.

In certain embodiments, the load balancers 486, 496 may be used to distribute network traffic received via the application 484 and/or the client device 20. The load balancers 486, 496 may include hardware load balancers, software load balancers, or a combination thereof. The first load balancer 486 may be used to facilitate application load balancing. For example, the application 484 may run using multiple servers. As such, the first load balancer 486 may be used to analyze requested content and redirect traffic to particular servers of the application 484 used to handle particular operations. The second load balancer 496 may be used to facilitate network load balancing, data center load balancing, and the like. For example, requests from the client device 20 may originate from one or more data centers across the enterprise. The data centers may be based in various geographical locations. As such, the second load balancer 496 may be used to distribute traffic to particular data centers based on a location of the client device 20. In some embodiments, the second load balancer 496 may redistribute requests to balance traffic.

In some embodiments, the scheduler service 488 may be used to schedule performance tests to be run on the application 484. The scheduler service 488 may receive a portion of code that may include instructions based on one or more dependencies of execution the performance test. In some embodiments, the scheduler service 488 may access the portion of code from a distributed version control system 498. The distributed version control system 498 may be used to organize code to ensure that the scheduler service 488 accesses up-to-date code that may be used to inform performance test scheduling. In certain embodiments, the distributed version control system 498 may also include code related to test scripts and/or data files that may be used in performance testing. As such, the schedular service may schedule and provide one or more testing scenarios for execution by the testing jobs 290.

In certain embodiments, the scheduler service 488 may determine various points in time to execute performance testing on the application 484. For example, the scheduler service 488 may be used to calendar performance test of the application 484 based on historical usage data associated with the application 484. Further, the scheduler service 488 may provide a testing schedule specifying that the performance test is executed weekly at a predetermined time. Additionally and/or alternatively, the scheduler service 488 may be used to establish automated performance testing. Automation of the performance testing may be used to collect performance metrics throughout development, deployment, and maintenance of the application 484. In certain embodiments, the scheduler service 488 may establish the testing schedule by interfacing with the CI/CD platform of the enterprise. As such, the scheduler service 488 may be used to generate automatic check points to assess performance of the application 484 as it moves through various stages of the CI/CD platform.

With this in mind, in certain embodiments, the scheduler service 488 may prompt execution of the performance test by executing the testing jobs 490. The testing jobs 490 may be used to test for various performance characteristics as described within the initialization stage 404 of the framework 400 of FIG. 5. For example, a first testing job 500 may be executed to test performance of the application 484 during varying database volumes. A second testing job 502 may be executed to test performance of the application 484 under increased capacity. A third testing job 504 may be executed to test performance of the application 484 under a surge or spike of requests. A fourth testing job 506 may be executed to test performance of the application 484 to determine a breakpoint of the application 484 during heavy load conditions. Data collected during execution of the testing jobs 490 may be collated into a single performance test. Data of each testing job 500, 502, 504, 506 and/or the single performance test may be stored in the databases 492 of the enterprise.

In some embodiments, the graphical user interface (GUI) 494 may be generated to provide insight to the data collected during performance testing. As such, the performance testing tool 306 may provide (e.g., generate and/or cause the display of) the GUI 494 to the client device 20 via a display. With this in mind, FIG. 7 is a schematic embodiment of a GUI (e.g., the GUI 494) of the performance testing tool 306 depicted as displayed on a screen 540. In some embodiments, the GUI 494 may be generated during the analysis stage 410 of the framework 400 of the performance testing tool 306 as described in reference to FIG. 5. As such, the GUI 494 may display the screen 540 to provide information related to the performance data and/or the performance metrics. In certain embodiments, the GUI 494 may allow the client device 20 to select one or more performance characteristics to analyze and/or manage. As such, the GUI 494 may have a performance parameter field 542, an application field 544, a testing job field 546, or a combination thereof that may be used to generate a performance report 548 of a specific performance characteristic, a specific application, a specific testing job, or a combination thereof.

In some embodiments, the GUI 494 may allow the client device 20 to select, view, and/or manage one or more performance parameter fields 550 within the performance report 548. The performance parameter fields 550 may include information related to particular testing jobs, a performance test, performance data, performance metrics, and the like. The performance parameter field 542 may include a concurrent user field 552, a total request field 554, a total errors field 556, a success rate field 558, an error rate field 560, a received bytes field 562, a sent bytes field 564, or a combination thereof. It should be noted, that the illustrated fields are a non-limiting example of the performance parameter fields 550 and different, more, or fewer fields may be included.

In certain embodiments, the GUI 494 may include one or more graphical representations 566 of the performance tests. For example, the graphical representations 566 may include a total throughput graph 568, a network traffic graph 570, and/or additional graphs. The total throughput graph 568 may display a time series plot of data related to a number of transactions per second 572 and a number of errors per second 574 during a period of time 576 as a function of a number of requests made per second 578. The total throughput graph 568 may also may indicate user activity 580 based on a number of concurrent users 582 during the period of time 576. The network traffic graph 570 may display a time series plot of data related to incoming and outgoing requests from concurrent users. As such, the network traffic graph may include an amount of sent bytes 584 and a number of received bytes 586 during a period of time 588 as a function of mebibytes per second 590.

In some embodiments, the performance testing tool 306 may generate one or more additional screens of the GUI 494 such as live displays during execution of performance testing. FIG. 8 is a schematic illustration of a screen 600 displaying a live performance testing session 602 of the performance testing tool 306. The live performance testing session 602 may include an error window 604 and an error information window 606. The error window 604 may be populated by the performance testing tool 306 in near real-time as multiple testing jobs are executed. As shown, one or more testing jobs 608 may be displayed on a graph 610. The graph 610 may be generated in near real-time over a period of time 612 as the performance test is executed. The graph 610 may display a number of errors 614 for each of the testing jobs 608. The testing jobs 608 may include a first testing job 616, a second testing job 618, a third testing job 620, a fourth testing job 622, a fifth testing job 624, a sixth testing job 626, and so forth. Each of the testing jobs 608 may include a total error counter 628. The total error counter 628 may be updated in near real-time to provide a snapshot related to performance of the application being tested.

The error information window 606 may be generated to provide additional information about errors displayed in the graph 610. As such, the error information window 606 may output one or more response codes 630 and one or more response messages 632 for each error found in the testing job 608. In this manner, it should be noted, that the response codes 630 and the response messages 632 displayed on the error information window 606 may only represent a portion of errors of the performance test. The error information window 606 may also include an error total 634 that may include a sum of all errors found in the testing jobs 608.

In some embodiments, the live performance testing session 602 may be used to identify potential bottlenecks and/or patterns of operations during the performance test in near real-time. In this manner, the performance testing tool 306 may be used to gain a granular level of detail of operations of the application as the performance testing tool 306 tests for the performance characteristics. For example, the testing jobs 608 may test a particular performance characteristic in various testing environments. As such, the particular performance characteristic may be probed by the testing jobs 608 in near real-time. In this manner, sources of errors generated during performance testing may be determined by the performance testing tool 306. The performance testing tool 306 may provide recommendations to optimize the applications to decrease occurrences of errors due to bottlenecks, slow patterns, and the like.

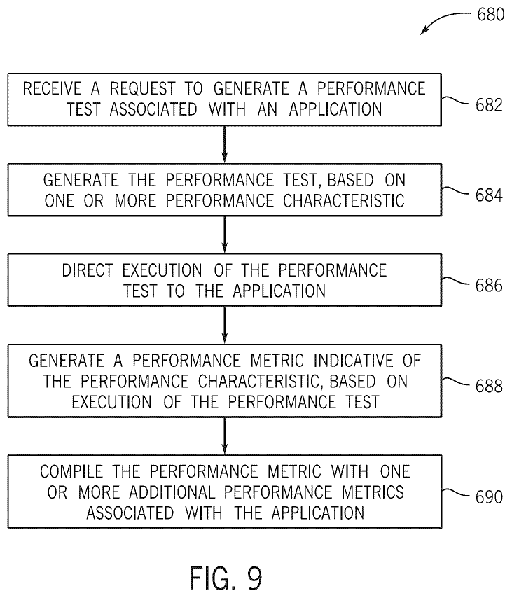

FIG. 9 provides a process 680 of performing a performance test and generating one or more performance metrics. The process 680 may be performed by the client device 20, a computing device or controller disclosed above with reference to FIG. 1 or any other suitable computing device(s) or controller(s). Furthermore, the blocks of the process 680 may be performed in the order disclosed herein or in any suitable order. For example, certain blocks of the process may be performed concurrently. In addition, in certain embodiments, at least one of the blocks of the process 680 may be omitted.

At block 682 of the process 680, the performance testing tool 306 may receive a request to generate a performance test associated with an application. In some embodiments, the request may be from a user profile via the client device 20, an additional client device, an automatic request from the CI/CD platform of the enterprise, and the like. The request may include one or more performance characteristics to be tested by the performance test. The performance characteristics may be used to identify various operations of the application to test. For example, the performance characteristics may include a load capacity, a scalability, a speed, a responsiveness, a stability, a load time, and the like. At block 684 of the process 680, the performance testing tool 306 may generate the performance test based on the performance characteristic. In certain embodiments, generation of the performance test may include scheduling a time for the performance test to be executed, determining a testing environment in which to perform the performance test, generating one or more test scripts associated with executing the performance test, or a combination thereof.

At block 686 of the process 680, the performance testing tool 306 may direct execution of the performance test to the application. Execution of the performance test may include testing the performance characteristic by simulating a scenario in which the application is under a particular load. The performance test may simulate generation of various requests of the application. In some embodiments, execution of the performance test may also include collecting performance data indicative of the application's response to the scenario simulated by the performance testing tool 306. The performance data may include response times, wait times, load times, errors, amount of concurrent users, requests per second, amount of transactions, throughput, hardware utilization, network utilization, memory utilization, and the like. The performance data may be stored in databases of the performance testing tool 306.

At block 688 of the process 680, the performance testing tool 306 may generate a performance metric indicative of the performance characteristic, based on execution of the performance test. The performance metric may be based on the performance data collected during the performance test. The performance metric may include error rates, load balancing rates, hardware utilization percentages, memory utilization percentages, network utilization percentages, comparisons of the performance data from additional performance tests, and the like.

At block 690 of the process 680, the performance testing tool 306 may compile the performance metric with one or more additional performance metrics associated with the application. In some embodiments, the compiled performance metrics may be output as a performance report. The compiled performance metrics (e.g., the performance report) may include performance analytics of various performance characteristics analyzed by the performance test. The compiled performance metrics may include a performance score related to an operational strength of the application. For example, the performance score may be used to compare performance of the application at various points in time. As such, performance of the application may be monitored as the application moves through a development process. Further, the performance score may be used to compare various applications of the enterprise to each other. In this manner, the performance score may be used to prioritize optimization of a first application with a lower performance score over a second application with a higher performance score. As such, the performance testing tool 306 may increase an efficiency of the enterprise by identifying applications in greatest need of optimization by an IT specialist.

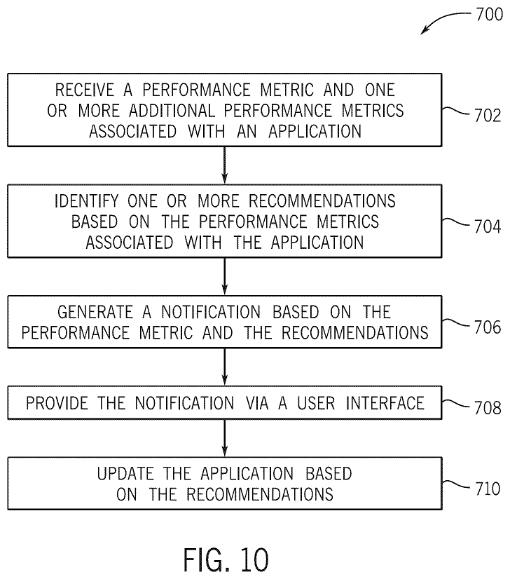

FIG. 10 provides a process 700 of performing a performance test and generating one or more performance metrics. The process 700 may be performed by the client device 20, a computing device or controller disclosed above with reference to FIG. 1 or any other suitable computing device(s) or controller(s). Furthermore, the blocks of the process 700 may be performed in the order disclosed herein or in any suitable order. For example, certain blocks of the process may be performed concurrently. In addition, in certain embodiments, at least one of the blocks of the process 700 may be omitted.

At block 702 of the process 700, the performance testing tool 306 may receive a performance metric and one or more additional performance metrics associated with an application. In some embodiments, the performance metric and the additional performance metrics associated with the application may be generated by the process 680 as described above. The performance metrics associated with the application may include a performance score. At block 704 of the process 700, the performance testing tool 306 may identify one or more recommendations based on the performance metrics associated with the application. The recommendations may include ways to increase efficiency of performance of the application tested by the performance testing tool 306. For example, the recommendations may include updating one or more hardware components, one or more software components, one or more network components, one or more CI/CD components, one or more portions of code, or a combination thereof.

At block 706 of the process 700, the performance testing tool 306 may generate a notification based on the performance metrics and the recommendations. The notification may include a report of the performance metrics and corresponding recommendations. At block 708 of the process 700, the performance testing tool 306 may provide the notification via a user interface. In some embodiments, the notification may be displayed graphically to illustrate performance of the application. Further, the notification may include display of an anticipated change in performance upon implementation of the recommendations. In this manner, the notification may be provided to the client device 20 to provide context of the performance metrics generated by the performance test. In certain embodiments, the notifications may be aligned with interests of the enterprise to guide improvements during application development and/or deployment based on performance goals.

With This in Mind, at Block 710 of the Process 700, the Performance Testing tool 306 may update the application based on the recommendations. For example, the recommendations may be implemented to increase an ability of the application to support a work load by updating a software component used by the application. In some embodiments, the performance testing tool 306 may execute a performance test on the application after integration of the recommendations. In this manner, the performance metrics of the application may be compared to determine if the recommendations improved performance of the application. As such, the performance testing tool 306 may provide performance degradation monitoring during a development process of applications within the enterprise.

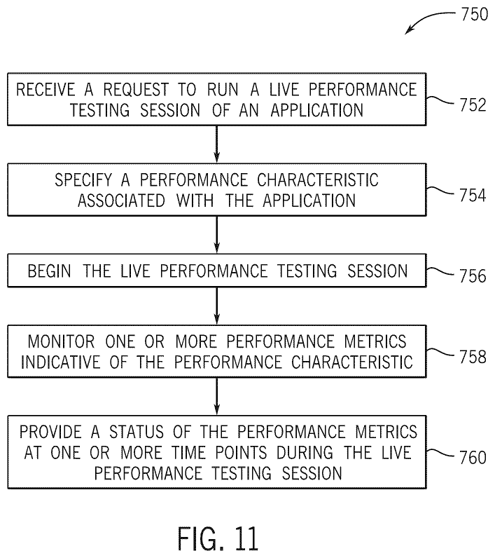

FIG. 11 provides a process 750 a process for performing a live performance testing session. The process 750 may be performed by the client device 20, a computing device or controller disclosed above with reference to FIG. 1 or any other suitable computing device(s) or controller(s). Furthermore, the blocks of the process 750 may be performed in the order disclosed herein or in any suitable order. For example, certain blocks of the process may be performed concurrently. In addition, in certain embodiments, at least one of the blocks of the process 750 may be omitted.

At block 752 of the process 750, the performance testing tool 306 may receive a request to run a live performance testing session of an application. The live performance testing session may provide near real-time data associated with a performance of an application. The live performance testing session may be used to identify sources of errors of the application during execution of a performance test. The live performance testing session may be used by IT specialists and/or clients of the enterprise to identify performance issues at various points of development and deployment of applications across the enterprise. The live performance testing session may be provided on a GUI. In this manner, the live performance testing may receive inputs from client devices. As such, the live performance testing session may test performance of the application in various scenarios (e.g., testing environments, number of users) to provide insight the application's ability to handle a scalability, a load, a stress, and the like.

At block 754 of the process 750, the performance testing tool 306 may specify a performance characteristic associated with the application. The performance characteristic may include a load capacity, a scalability, a speed, a responsiveness, a stability, a load time, and the like. At block 756 of the process 750, the performance testing tool 306 may begin the live performance testing session. The performance testing tool 306 may provide continuous updates to the live performance testing session. Updates may be made in near real-time to provide insight to performance of the application at various points in time during execution of the performance test. As such, the live performance testing session may provide the client device 20 with performance data of the application and a corresponding portion of a test script used to execute the performance test.

At block 758 of the process 750, the performance testing tool 306 may monitor one or more performance metrics indicative of the performance characteristic. The performance metrics may include results based on analysis of performance of the application. The performance metrics may include error rates, load balancing rates, hardware utilization percentages, memory utilization percentages, network utilization percentages, and the like. In this manner, the live performance testing session may be analyzed based on stress, load, and the like simulated by the performance testing tool 306.

At block 760 of the process 750, the performance testing tool 306 may provide a status of the performance metrics at one or more time points during the live performance testing session. As such, the performance testing tool 306 may provide analysis in near real-time. Additionally and/or alternatively, the status of the performance metrics may be compared to a prior performance test. In this manner, the status of the performance metrics at time points may be compared to performance of a different version of the application at similar time points. Such comparison may provide insight to performance degradation and/or performance regression of the application.

The present disclosure is directed to a performance testing tool to streamline performance testing for applications of an enterprise. In this manner, the performance testing tool 306 may automatically identify performance metrics related to various software products, generate performance reports in real-time or near-real-time, and provide performance analytics based on performance reports. The performance testing tool 306 may also be integrated with a CI/CD platform of the enterprise to provide testing of software products within pre-existing architectures. Additionally, present embodiments include creation of GUIs designed to provide near real-time insight into live performance testing sessions and/or display performance reports within the platform of the enterprise. In this manner, the performance testing tool 306 provides streamlined access to performance analytics. Integration of the performance testing tool 306 on the platform of the enterprise allows streamlined performance testing during development, deployment, and/or maintenance of various software products. Previously, integrated performance testing within the platform of the enterprise was cumbersome and/or unsupported. By streamlining performance testing through incorporation of the performance testing tool 306, overall performance in software products of the enterprise may be centrally monitored. The disclosed techniques result in better integration of performance testing and access to comparable performance reports, which improves end user experiences of cloud computing services offered by the enterprise.

Technical effects of the disclosed techniques include use of a performance testing tool to provide performance testing to various software products of an enterprise. The performance testing tool 306 may include various stages such as an initialization stage, a scheduling stage, a testing stage, and an analysis stage. The performance testing tool 306 may result in reduced computational costs associated with less time spent propagating performance testing across software products of the enterprise. Further, deployment of the presently disclosed techniques may provide improved efficiency and performance of integrating performance testing within a CI/CD platform of the enterprise. Additionally, the performance testing tool 306 may be used to automatically prompt performance testing to prevent performance degradation and/or performance regression of the various software products of the enterprise.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]. . . ” or “step for [perform]ing [a function]. . . ”, it is intended that such elements are to be interpreted under 35 U.S.C. 112(f). However, for any claims containing elements designated in any other manner, it is intended that such elements are not to be interpreted under 35 U.S.C. 112(f).

1. A method comprising:
receiving a request to generate a performance test associated with an application, wherein the request specifies a performance characteristic associated with the application;
generating, based on the performance characteristic, the performance test;
directing execution of the performance test to the application;
generating, based on execution of the performance test, a performance metric indicative of the performance characteristic; and
compiling the performance metric with one or more additional performance metrics associated with the application.

2. The method of claim 1, wherein the performance metric comprises a pattern, a scalability, a load score, a stress score, a hardware utilization score, a semaphore utilization score, or any combination thereof.

3. The method of claim 1, wherein outputting the performance metric comprises:
generating a notification based on the performance metric; and
providing the notification via a user interface.

4. The method of claim 3, comprising:
generating the notification, via the user interface, during generation of the performance test associated with the application.

5. The method of claim 1, wherein receiving the request to generate the performance test comprises:
accessing a continuous integration (CI) /continuous deployment (CD) pipeline.

6. The method of claim 5, wherein the CI/CD pipeline is configured to automatically generate requests based on a status of the application.

7. The method of claim 1, comprising updating the application based on the performance metric.

8. The method of claim 1, comprising:
receiving a request to run a live performance testing session of the application;
identifying a specific performance characteristic to test during the live performance testing session;
initiating the live performance testing session; and
monitoring one or more performance metrics indicative of the specific performance characteristic.

9. The method of claim 8, wherein the live performance testing session provides near-real time updates of the performance metrics.

10. The method of claim 1, wherein compiling the performance metric with one or more additional performance metrics associated with the application comprises generating a performance report.

11. A system, comprising:
processing circuitry; and
memory, accessible by the processing circuitry, the memory storing instructions that, when executed by the processing circuitry, cause the processing circuitry to perform operations comprising:
receiving a request to generate a performance test associated with an application, wherein the request specifies a performance characteristic associated with the application;
generating, based on the performance characteristic, the performance test;
directing execution of the performance test to the application;
generating, based on execution of the performance test, a performance metric indicative of the performance characteristic; and
compiling the performance metric with one or more additional performance metrics associated with the application.

12. The system of claim 11, wherein the performance metric comprises a pattern, a scalability, a load score, a stress score, a hardware utilization score, a semaphore utilization score, or any combination thereof.

13. The system of claim 11, wherein outputting the performance metric comprises:
generating a notification based on the performance metric; and
providing the notification via a user interface.

14. The system of claim 13, comprising:
generating the notification, via the user interface, during generation of the performance test associated with the application.

15. The system of claim 11, wherein receiving the request to generate the performance test comprises:
accessing a continuous integration (CI) /continuous deployment (CD) pipeline.

16. The system of claim 15, wherein the CI/CD pipeline is configured to automatically generate requests based on a status of the application.

17. A non-transitory computer-readable storage medium, comprising processor-executable routines that, when executed by a processor, cause the processor to perform operations comprising:
receiving a request to generate a performance test associated with an application, wherein the request specifies a performance characteristic associated with the application;
generating, based on the performance characteristic, the performance test;
directing execution of the performance test to the application;
generating, based on execution of the performance test, a performance metric indicative of the performance characteristic;
compiling the performance metric with one or more additional performance metrics associated with the application;
generating a notification based on the compiled performance metrics; and
providing the notification to a client device via a user interface.

18. The non-transitory computer-readable storage medium of claim 17, wherein the performance metric comprises a pattern, a scalability, a load score, a stress score, a hardware utilization score, a semaphore utilization score, or any combination thereof.

19. The non-transitory computer-readable storage medium of claim 17, wherein receiving the request to generate the performance test comprises:
accessing a continuous integration (CI)/continuous deployment (CD) pipeline.

20. The non-transitory computer-readable storage medium of claim 17, wherein the CI/CD pipeline is configured to automatically generate requests based on a status of the application.
